(19) United States
(12) Patent Application Publication
(10) Pub. No.: US 2026/0081524 A1
(43) Pub. Date: Mar. 19, 2026

(54) BANDGAP REFERENCE AND BIAS CURRENT GENERATOR

(71) Applicant: QUALCOMM Incorporated, San Diego, CA (US)

(72) Inventors: Fuqiang WAN, San Diego, CA (US); Dongmin PARK, San Diego, CA (US)

(21) Appl. No.: 18/888,090

(22) Filed: Sep. 17, 2024

(51) Int. Cl. H02M 3/158

(52) U.S. Cl. CPC H02M 3/158

(57) ABSTRACT

Certain aspects of the present disclosure generally relate to techniques and apparatus for bandgap current generation. One example apparatus generally includes: a first amplifier; a first diode coupled to a first input of the first amplifier; a second diode coupled to a second input of the first amplifier; a first transistor having a gate coupled to an output of the first amplifier and an drain coupled to a current combining node; a first current mirror; and a voltage follower including a first voltage follower node coupled to the second input of the first amplifier and a second voltage follower node coupled to a first branch of the first current mirror, wherein a second branch of the first current mirror is coupled to the current combining node.

### TECHNICAL FIELD

Certain aspects of the present disclosure generally relate to electronic circuits and, more particularly, to circuits and techniques for bandgap current generation.

### BACKGROUND

Many electronic circuits use a bandgap voltage or current reference. A bandgap voltage or current reference generally refers to a voltage or current that is designed to be largely constant with respect to temperature. The temperature stability of the bandgap voltage or current reference is important for the accurate operation of analog and digital circuits, especially given the wide variation of conditions that circuits are expected to operate under. In some cases, bandgap voltage or current references may be used in frequency synthesizers to generate a local oscillator (LO) signal for upconversion and downconversion of signals.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure are directed towards an apparatus for current generation. The apparatus generally includes: a first amplifier; a first diode coupled to a first input of the first amplifier; a second diode coupled to a second input of the first amplifier; a first transistor having a gate coupled to an output of the first amplifier and a drain coupled to a current combining node; a first current mirror; and a voltage follower including a first voltage follower node coupled to the second input of the first amplifier and a second voltage follower node coupled to a first branch of the first current mirror, wherein a second branch of the first current mirror is coupled to the current combining node.

Certain aspects of the present disclosure are directed towards a method for current generation. The method generally includes: generating, via an amplifier, an amplified signal based on a first voltage at a first input of the amplifier and a second voltage at a second input of the amplifier, wherein a first diode is coupled to the first input of the amplifier and a second diode is coupled to the second input of the amplifier; generating a first current based on the amplified signal; generating, via a voltage follower circuit, a third voltage that follows the first voltage; generating, via a first current mirror, a second current based on the third voltage; and combining the first current and the second current to generate a third current.

Certain aspects of the present disclosure are directed towards a wireless device. The wireless device generally includes one or more mixers and one or more synthesizers including one or more outputs coupled to one or more local oscillator (LO) inputs of the one or more mixers, respectively, wherein each of the one or more synthesizers includes: a first amplifier; a first diode coupled to a first input of the first amplifier; a second diode coupled to a second input of the first amplifier; a first transistor having a gate coupled to an output of the first amplifier and a drain coupled to a current combining node; a first current mirror; and a voltage follower including a first voltage follower node coupled to the second input of the first amplifier and a second voltage follower node coupled to a first branch of the first current mirror, wherein a second branch of the first current mirror is coupled to the current combining node.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in which aspects of the present disclosure may be practiced.

FIG. 2 is a block diagram conceptually illustrating a design of an example base station (BS) or access point (AP) and user equipment (UE), in which aspects of the present disclosure may be practiced.

FIG. 3 is a block diagram of an example radio frequency (RF) transceiver, in which aspects of the present disclosure may be practiced.

FIG. 4 illustrates a bandgap current generation circuit, in accordance with certain aspects of the present disclosure.

FIG. 5 illustrates an example of a flipped voltage follower, in accordance with certain aspects of the present disclosure.

FIG. 6 illustrates graphs showing the impact of a second-order effect associated with a diode pair.

FIG. 7 illustrates a bandgap current generation circuit implemented with an operational amplifier, in accordance with certain aspects of the present disclosure.

FIG. 8 is a flow diagram illustrating example operations for current generation, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed toward a bandgap current generation circuit. The bandgap current generation circuit may include an amplifier with inputs coupled to diodes (e.g., referred to herein as a “diode-pair”), which may be implemented as bipolar junction transistors (BJTs). The forward voltage of the diodes (e.g., the emitter-to-base voltage of the BJTs) may decrease with increasing temperature. The amplifier may generate an output signal to drive a transistor to generate a current (I_ptu) that is proportional to temperature. In some aspects, the generation circuit may include a flipped voltage follower (FVF) that may receive an input voltage of the amplifier and generate a voltage that follows the input voltage of the amplifier based on which a current (I_ctu) that is complementary to temperature may be generated. I_ctu and I_ptu may be combined to generate a bandgap current (I_bgu). In some cases, I_bgu may be mirrored via a current mirror to generate a tail current for the amplifier of the generation circuit. Transistors of the current mirror may be coupled in cascode with respective transistors (e.g., cascode transistors). A temperature effect mismatch between one or more of the transistors of the current mirror and a cascode transistor may be configured to compensate (or at least adjust) for a second-order effect of the diode pair, as described in more detail herein. In some aspects, the generation circuit may also include a startup circuit that may be used to precharge a capacitive element in order to charge a gate of a tail transistor of the amplifier, allowing for quicker startup of the generation circuit.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

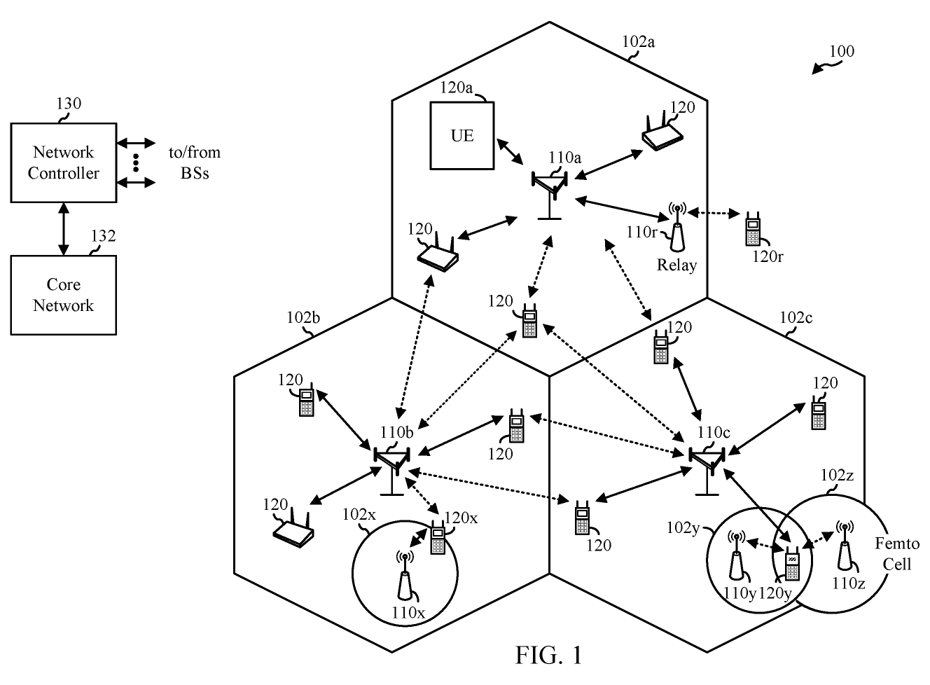

FIG. 1 illustrates an example wireless communications network 100, in which aspects of the present disclosure may be practiced. For example, the wireless communications network 100 may be a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation/Third Generation (2G/3G) network), or a code division multiple access (CDMA) system (e.g., a 2G/3G network), or may be configured for communications according to an IEEE standard such as one or more of the 802.11 standards, etc.

As illustrated in FIG. 1, the wireless communications network 100 may include a number of base stations (BSs) 110a-z (each also individually referred to herein as “BS 110” or collectively as “BSs 110”) and other network entities. A BS may also be referred to as an access point (AP), an evolved Node B (eNodeB or eNB), a next generation Node B (gNodeB or gNB), or some other terminology.

A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communications network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with one or more user equipments (UEs) 120a-y (each also individually referred to herein as “UE 120” or collectively as “UEs 120”) in the wireless communications network 100. A UE may be fixed or mobile and may also be referred to as a user terminal (UT), a mobile station (MS), an access terminal, a station (STA), a client, a wireless device, a mobile device, or some other terminology. A user terminal may be a wireless device, such as a cellular phone, a smartphone, a personal digital assistant (PDA), a handheld device, a wearable device, a wireless modem, a laptop computer, a tablet, a personal computer, etc.

The BSs 110 are considered transmitting entities for the downlink and receiving entities for the uplink. The UEs 120 are considered transmitting entities for the uplink and receiving entities for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink. Nup UEs may be selected for simultaneous transmission on the uplink, Ndn UEs may be selected for simultaneous transmission on the downlink. Nup may or may not be equal to Ndn, and Nup and Ndn may be static values or can change for each scheduling interval. Beam-steering or some other spatial processing technique may be used at the BSs 110 and/or UEs 120.

The UEs 120 (e.g., 120x, 120y, etc.) may be dispersed throughout the wireless communications network 100, and each UE 120 may be stationary or mobile. The wireless communications network 100 may also include relay stations (e.g., relay station 110r), also referred to as “relays” or the like, that receive a transmission of data and/or other information from an upstream station (e.g., a BS 110a or a UE 120r) and send a transmission of the data and/or other information to a downstream station (e.g., a UE 120 or a BS 110), or that relays transmissions between UEs 120, to facilitate communication between devices.

The BSs 110 may communicate with one or more UEs 120 at any given moment on the downlink and uplink. The downlink (i.e., forward link) is the communication link from the BSs 110 to the UEs 120, and the uplink (i.e., reverse link) is the communication link from the UEs 120 to the BSs 110. A UE 120 may also communicate peer-to-peer with another UE 120.

The wireless communications network 100 may use multiple transmit and multiple receive antennas for data transmission on the downlink and uplink. BSs 110 may be equipped with a number Nap of antennas to achieve transmit diversity for downlink transmissions and/or receive diversity for uplink transmissions. A set Nu of UEs 120 may receive downlink transmissions and transmit uplink transmissions. Each UE 120 may transmit user-specific data to and/or receive user-specific data from the BSs 110. In general, each UE 120 may be equipped with one or multiple antennas. The Nu UEs 120 can have the same or different numbers of antennas.

The wireless communications network 100 may be a time division duplex (TDD) system or a frequency division duplex (FDD) system. For a TDD system, the downlink and uplink share the same frequency band. For an FDD system, the downlink and uplink use different frequency bands. The wireless communications network 100 may also utilize a single carrier or multiple carriers for transmission. Each UE 120 may be equipped with a single antenna (e.g., to keep costs down) or multiple antennas (e.g., where the additional cost can be supported).

A network controller 130 (also sometimes referred to as a “system controller”) may be in communication with a set of BSs 110 and provide coordination and control for these BSs 110 (e.g., via a backhaul). In certain cases (e.g., in a 5G NR system), the network controller 130 may include a centralized unit (CU) and/or a distributed unit (DU). In certain aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

The UE 120 and/or BS 110 may be implemented with a bandgap current generation circuit, as described in more detail herein.

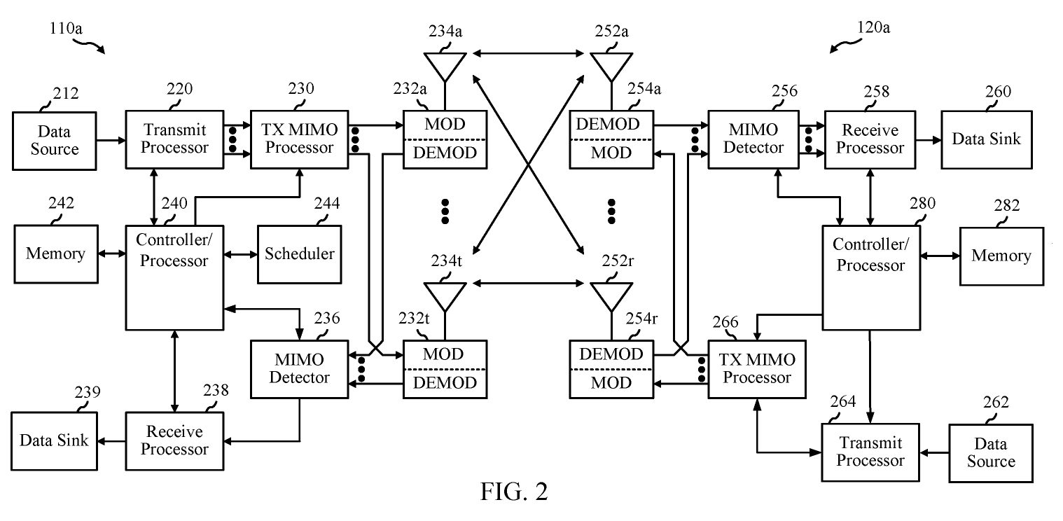

FIG. 2 illustrates example components of BS 110a and UE 120a (e.g., from the wireless communications network 100 of FIG. 1), in which aspects of the present disclosure may be implemented.

On the downlink, at the BS 110a, a transmit processor 220 may receive data from a data source 212, control information from a controller/processor 240, and/or possibly other data (e.g., from a scheduler 244). The various types of data may be sent on different transport channels. For example, the control information may be designated for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be designated for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS).

A transmit (TX) multiple-input, multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. The memories 242 and 282 may also interface with the controllers/processors 240 and 280, respectively. A scheduler 244 may schedule UEs for data transmission on the downlink and/or uplink.

The transceivers 232a-232t and/or transceivers 254a-254r may be implemented with a bandgap current generation circuit, as described in more detail herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

### Example RF Transceiver

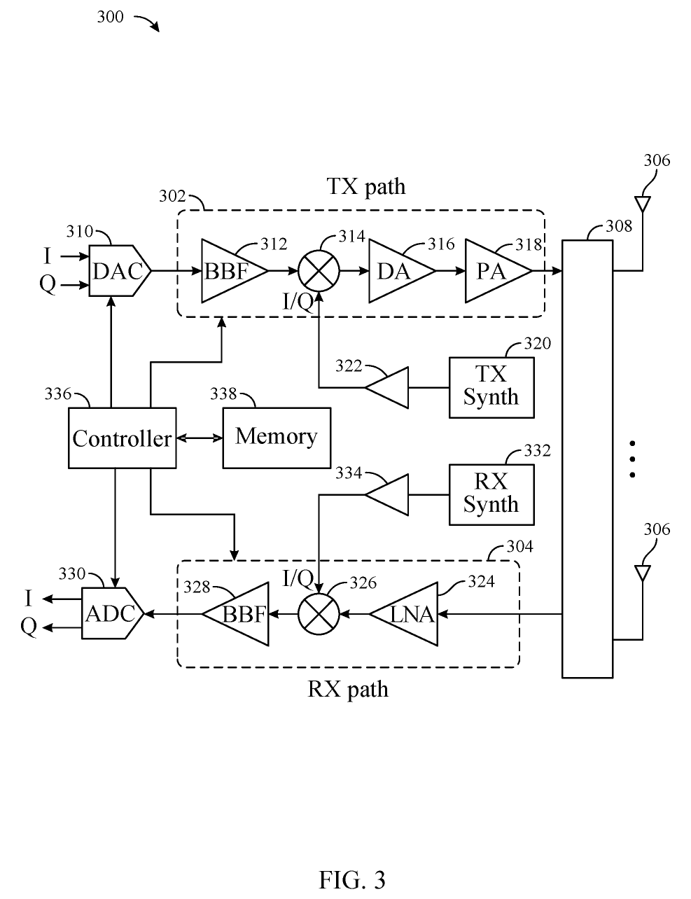

FIG. 3 is a block diagram of an example radio frequency (RF) transceiver circuit 300, in accordance with certain aspects of the present disclosure. The RF transceiver circuit 300 includes at least one transmit (TX) path 302 (also known as a “transmit chain”) for transmitting signals via one or more antennas 306 and at least one receive (RX) path 304 (also known as a “receive chain”) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) and/or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, the DA 316, and the PA 318 may be included in a radio frequency integrated circuit (RFIC). For certain aspects, the PA 318 may be external to the RFIC.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency-conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 314 are typically RF signals, which may be amplified by the DA 316 and/or by the PA 318 before transmission by the antenna(s) 306. While one mixer 314 is illustrated, several mixers may be used to upconvert the filtered baseband signals to one or more intermediate frequencies and to thereafter upconvert the intermediate frequency (IF) signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna(s) 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I and/or Q signals for digital signal processing.

Certain transceivers may employ frequency synthesizers with a variable-frequency oscillator (e.g., a voltage-controlled oscillator (VCO) or a digitally controlled oscillator (DCO)) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326. For certain aspects, a single frequency synthesizer may be used for both the TX path 302 and the RX path 304. In certain aspects, the TX frequency synthesizer 320 and/or RX frequency synthesizer 332 may include a frequency multiplier, such as a frequency doubler, that is driven by an oscillator (e.g., a VCO) in the frequency synthesizer. In some aspects, at least one of the synthesizers 320, 332 may be implemented with a bandgap current generation circuit, as described in more detail herein.

A controller 336 (e.g., controller/processor 280 in FIG. 2) may direct the operation of the RF transceiver circuit 300A, such as transmitting signals via the TX path 302 and/or receiving signals via the RX path 304. The controller 336 may be a processor, a digital signal processor (DSP), an application-specific integrated circuit (ASIC), a field-programmable gate array (FPGA) or other programmable logic device (PLD), discrete gate or transistor logic, discrete hardware components, or any combination thereof. A memory 338 (e.g., memory 282 in FIG. 2) may store data and/or program codes for operating the RF transceiver circuit 300. The controller 336 and/or the memory 338 may include control logic (e.g., complementary metal-oxide-semiconductor (CMOS) logic).

While FIGS. 1-3 provide wireless communications as an example application in which certain aspects of the present disclosure may be implemented to facilitate understanding, certain aspects described herein may be used for any of various other suitable systems.

### Example for Bandgap Current Generation Circuit

In modern transceivers, bandgap generation circuitry may be used to generate a reference voltage and a proportional to absolute temperature (PTAT) current. A bandgap reference voltage (Vbg) may be used in a low dropout (LDO) regulator to generate a constant reference voltage over temperature. PTAT current may be used for voltage-controlled oscillator (VCO) temperature drift compensation (e.g., for temperature drift compensation of a VCO within one or more synthesizers such as synthesizers 320 and 332). Separated bandgap cores may generate both untuned bandgap (BGU) current and untuned PTAT (PTU) current. Tuned bandgap and PTAT currents refer to bandgap and PTAT currents that are tuned to compensate (or at least adjust) for impedance changes of a load due to variations in temperature.

Each bandgap core may include a feedback operational amplifier (OPAMP). The bandgap core may include one or more diodes, and second-order temperature effects of the diodes may impact the bandgap voltage (Vbg) over temperature. Moreover, the bandgap core may take a long time (e.g., 10 µs) to start up. Due to the large area of the bandgap core, a single bandgap core may be used to generate bias currents for multiple modules (e.g., synthesizers), where a long routing may be used to provide the generated bandgap current to each of the modules. The bias current routing length from bandgap core to some modules may be several millimeters, which can impact the bias current, especially when the modules are turned off and on.

Certain aspects of the present disclosure are directed towards a bandgap reference and bias current generator circuit that combines the generation of BGU and PTU currents into a single bandgap core. In some aspects, the bandgap core may be implemented using a flipped voltage follower (FVF) matching pair, reducing the area consumption of the bandgap core as compared to using an operational amplifier. The bandgap core may compensate for (or at least reduce) diode second-order temperature effects and may include a startup circuit that saves startup settling time with a precharged storage capacitive element, as described in more detail herein. While some examples provided herein are described with respect to untuned bandgap and PTAT currents, certain aspects may be implemented to generate any suitable bandgap currents.

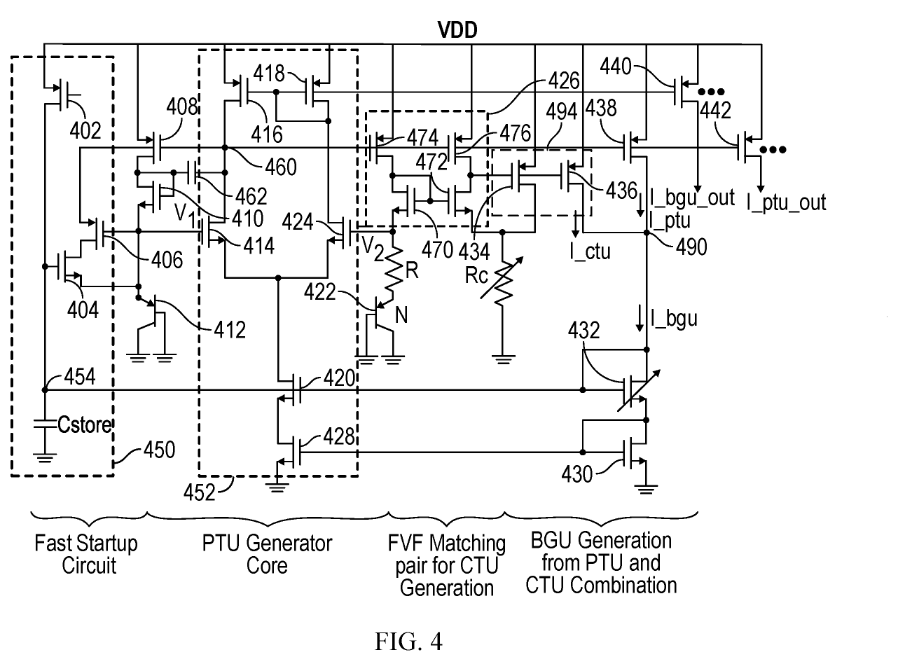

FIG. 4 illustrates a bandgap current generation circuit 400, in accordance with certain aspects of the present disclosure. As shown, the circuit 400 may include a startup circuit 450, including a p-type metal-oxide-semiconductor (PMOS) transistor 402 (e.g., also referred to as “an enable transistor”) with a gate that may receive an enable signal. A source of the transistor 402 may be coupled to a voltage rail providing a supply voltage (VDD), and a drain of transistor 402 may be coupled to a storage capacitive element labeled “Cstore.” The transistor 402 may be turned on via the enable signal during a startup phase, charging Cstore to VDD. As shown, Cstore may be coupled between a startup circuit node 454 and a reference potential node (e.g., electric ground), where node 454 is coupled to the gates of n-type metal-oxide-semiconductor (NMOS) transistors 420, 432. Thus, VDD may be provided to gates of transistors 420, 432, precharging the gate capacitance of transistors 420, 432 and enabling an amplifier 452. The transistor 420 may implement part of a tail current source (e.g., also referred to as a “tail transistor”) for the amplifier 452 having inputs receiving voltages V₁ and V₂ (e.g., referred to as “V₁ node” and “V₂ node,” respectively).

As shown, the node 454 may be coupled to a gate of an NMOS transistor 404 of the startup circuit 450, where a source of transistor 404 is coupled to the reference potential node through a diode-connected transistor 412 (e.g., a diode-connected PNP bipolar junction transistor (BJT)). For example, the base and collector of the transistor 412 may be coupled to the reference potential node, and the emitter of the transistor 412 may be coupled to the V₁ node. The startup circuit 450 may also include a PMOS transistor 406 having a drain coupled to a drain of transistor 404 and a gate coupled to the V₁ node. When VDD is provided to the gate of transistor 404 during the startup phase, the transistor 404 is turned on, effectively coupling the drain of transistor 406 to the reference potential node through the diode-connected transistor 412. The V₁ node may be equal to zero volts plus an emitter-to-base voltage (Veb) of transistor 412. Thus, the PMOS transistor 406 is also turned on. As shown, the source of transistor 406 is coupled to a gate of a PMOS transistor 408. A source of transistor 408 may be coupled to the VDD rail, and a drain of transistor 408 may be coupled to the V₁ node through a diode-connected transistor 410. Thus, with the transistors 404, 406 being turned on, the gate of PMOS transistor 408 may be set to zero volts plus Veb of transistor 412, turning on transistor 408 and providing current from the VDD rail to the V₁ node through the forward-biased diode-connected transistor 410 to charge the V₁ node (e.g., resulting in V₁ increasing).

As shown, the amplifier 452 includes input transistors 414, 424 (e.g., NMOS transistors) having gates coupled to the V₁ and V₂ nodes, respectively, where sources of transistors 414, 424 are coupled to the drain of transistor 420, as shown. Drains of transistors 414, 424 are coupled to respective drains of transistors 416, 418, where sources of transistors 416, 418 are coupled to the VDD rail. The gate of transistor 418 is coupled to the drain of transistor 418, as shown. An output 460 of the amplifier 452 is coupled to the gate of transistor 408, providing a feedback path from the output 460 to the input (e.g., V₁ node) of amplifier 452 through transistors 408, 410. As shown, the output 460 may be coupled to the drain of transistor 408 (and the drain and gate of transistor 410) through a compensation capacitive element 462. With the amplifier turned on (e.g., by driving the gate of transistor 420 via the startup circuit 450), the amplifier 452 sets V₁ and V₂ at respective inputs of amplifier 452 to be equal.

As shown, a resistive element labeled “R” may be coupled between the V₂ node and an emitter of a transistor 422 (e.g., a PNP BJT). In some implementations, the transistor 422 may have a transistor size ratio N with respect to transistor 412, N being a positive number. The transistor 422 may be configured as a diode-connected transistor with the base and collector of transistor 422 being coupled to the reference potential node. As shown, a flipped voltage follower 426 may be coupled between the V₂ node and a V₃ node and used to set V₃ equal to V₂. The flipped voltage follower 426 may include an NMOS transistor 470 having a source coupled to the V₂ node and a drain coupled to a drain of a PMOS transistor 474, where a source of transistor 474 is coupled to the VDD rail. The gate of transistor 470 may be coupled to the drain of transistor 470 and to a gate of transistor 472. The source of transistor 472 may be coupled to the V₃ node, and the drain of transistor 472 may be coupled to a drain of transistor 476. The source of transistor 476 may be coupled to the VDD rail, and the gate of transistor 476 may be coupled to the gate of transistor 474. The V₃ node may be coupled to a reference potential node (e.g., electric ground) through a variable resistive element labeled “Rc.”

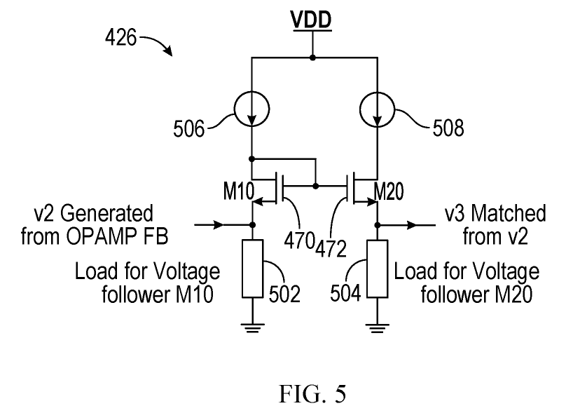

FIG. 5 illustrates an example flipped voltage follower 426, in accordance with certain aspects of the present disclosure. As shown, the flipped voltage follower 426 may include current sources 506, 508 which may be implemented via respective transistors 474, 476 shown in FIG. 4. The voltage V₂ at the source of transistor 470 (e.g., labeled “M10”) may be generated via amplifier feedback (e.g., operational amplifier (OPAMP) feedback or via amplifier 452 described with respect to FIG. 4). The source of transistor 470 may be coupled to load 502 for transistor 470. For example, the load 502 may correspond to resistive element R and transistor 422 described with respect to FIG. 4. As shown, the voltage follower 426 generates the voltage V₃ at the source of transistor 472 (labeled “M20”) where voltage V₃ follows (e.g., matches) voltage V₂. The V₂ node and the V₃ node may be referred to as “voltage follower nodes.” The source of transistor 472 may be coupled to a load 504 for transistor 472. The load 504 may correspond to the resistive element Rc shown in FIG. 4. In some cases, the resistance of the resistive element Rc may be adjustable. A flipped voltage follower generally refers to a voltage follower with a current source (e.g., such as the current source 508) between an input transistor (e.g., such as the transistor 472) and a voltage rail (e.g., VDD).

Referring back to FIG. 4, the drains of transistors 472, 476 may be coupled to a gate of transistor 434 and a gate of transistor 436, where the sources of transistors 434, 436 are coupled to the VDD rail. The drain of transistor 434 is coupled to the V₃ node, as shown. A current is sunk from the V₃ node to the reference potential node (e.g., electric ground) across the resistive element Rc. The resistive element Rc may be a variable resistive element with a resistance that may be adjusted to set the amount of current sunk from the V₃ node. The transistors 434, 436 form a current mirror 494, where transistor 434 (e.g., a current mirror transistor) forms one branch of the current mirror and transistor 436 forms another branch of the current mirror. Thus, the source-to-drain current of transistor 434 may be based on the current sunk from the V₃ node, and the source-to-drain current of transistor 434 is mirrored to generate an untuned complementary-to-temperature (CTU) current (I_ctu) from the source to the drain of transistor 436, as shown. Moreover, the gate of transistor 408 may be coupled to a gate of a transistor 438. A PTU current (I_ptu) is generated from the source to a drain of transistor 438. I_ctu and I_ptu are provided to a current combining node 490, as described in more detail herein.

With increasing temperatures, the Veb of transistor 412 decreases, resulting in a decrease in voltage V₁. Thus, the voltages V₂ and V₃ also decrease. With V₃ decreasing, the current sunk from the V₃ node across Rc decreases, resulting in a decrease in I_ctu. Thus, I_ctu is complementary to absolute temperature. In some aspects, the resistance of Rc may be adjusted to adjust I_ctu.

On the other hand, with increasing temperature, the Veb of transistor 412 and Veb of transistor 422 decrease. The output signal of amplifier 452 at the output 460 (e.g., coupled to the gate of transistor 438) is dependent on the Veb of transistor 412 and Veb of transistor 422. For example, amplifier 452 may effectively amplify the difference between the Veb of transistor 412 and the Veb of transistor 422 plus the voltage drop across resistive element R to drive the gates of transistor 438 and transistor 442. Thus, with increasing temperature, the Veb of transistor 412 and Veb of transistor 422 decrease, resulting in the voltage at output 460 decreasing (e.g., the gate voltage of PMOS transistors 438, 442 decreasing) and I_ptu increasing. Therefore, I_ptu is proportional to temperature. As shown, I_ptu is generated via transistor 438, and an output PTU current (I_ptu_out) is generated via transistor 442, where I_ptu_out is (nearly) equivalent to I_ptu.

I_ctu and I_ptu are provided to and combined at the current combining node 490 to generate the untuned bandgap current (I_bgu), as shown. In other words, with I_ctu being complementary to absolute temperature and I_ptu being proportional to absolute temperature, the temperature effects of I_ctu and I_ptu may be at least partially canceled out to provide I_bgu that may be constant (or at least more constant than I_ctu and I_ptu) with respect to changes in temperature. In some aspects, a transistor 440 with a source coupled to the VDD rail and a gate coupled to the gates of transistors 418, 416 may be used to provide an output BGU current (I_bgu_out). Vbg may be generated at the drain of the transistor 440. I_bgu from node 490 is mirrored via transistors 432, 420 to generate the tail current for amplifier 452. The source to drain current of transistor 418 is generated based on the tail current. The source-to-drain current of transistor 418 is mirrored to generate I_bgu_out. While a single transistor 440 is shown for generating a single output BGU current, multiple transistors may be used to generate multiple output BGU currents.

I_ptu may be generated by a diode pair (e.g., transistors 412, 422) and feedback amplifier 452. I_ctu is generated by the FVF matching pair (e.g., voltage follower 426 with transistors 470, 472). I_bgu is generated by combining I_ctu and I_ptu based on a current source device ratio (e.g., the ratio between the currents sourced by transistors 436, 438). Certain aspects are directed towards techniques for compensating for second-order temperature effects associated with the diode pair implemented via transistors 412, 422.

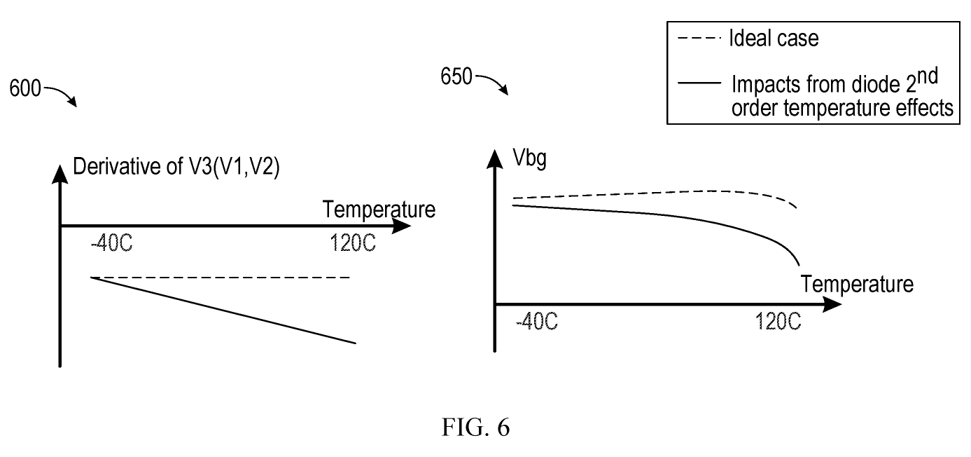

FIG. 6 illustrates graphs 600, 650 showing the impact of the second-order temperature effects associated with the diode pair (e.g., transistors 412, 422). Graph 600 shows the derivative of V₃ (e.g., which may also correspond to the derivatives of V₁ and V₂). As shown, ideally, the derivative (e.g., rate of change as a function of temperature) of V₃ would be constant with temperature. However, the derivative of V₃ decreases as temperature increases due to the second-order effects of the diode pair. Graph 650 shows Vbg as a function of temperature. As shown, due to the second-order effects of the diode pair, Vbg decreases with temperature, whereas in a more ideal scenario, Vbg would be more constant as a function of temperature as shown.

Referring back to FIG. 4, a current mirror may be implemented to mirror I_bgu to generate the tail current (e.g., bias current) for the amplifier 452. For example, the circuit 400 may include a current mirror implemented via an NMOS transistor 432 having a drain coupled to a gate of transistor 432 and current combining node 490 to receive I_bgu. The gate of transistor 432 may be further coupled to a gate of the transistor 420 (e.g., also referred to herein as a “tail transistor”) to generate the tail current sunk from the drains of input transistors 414, 424 of amplifier 452. The transistor 432 may form one branch of a current mirror, and the transistor 420 may form another branch of the current mirror.

In some aspects, the transistor 432 may be coupled in cascode with an NMOS transistor 430, and the transistor 420 may be coupled in cascode with an NMOS transistor 428. The cascode transistor 430 may include a gate coupled to a drain of the transistor 430 and a source of transistor 432. The gate of transistor 430 may be further coupled to a gate of the transistor 428. The transistor 428 may have a drain coupled to a source of transistor 420. The sources of transistors 428, 430 may be coupled to the reference potential node (e.g., electric ground), as shown. The transistor 432 may represent multiple transistors that may be selectively coupled in parallel to adjust the current mirror ratio used to generate the tail current for amplifier 452. In some aspects, the mismatch (e.g., a mismatch in temperature effect) between the transistor 432 and the cascode transistor 430 may be used to at least partially compensate for the second-order effects of the diode pair and provide a more constant derivative of V₁, V₂, and V₃ with respect to temperature and a more constant response of Vbg to temperature as shown in the more ideal scenario of graph 650.

While the example circuit 400 is described with a flipped voltage follower 426 to generate V₃ to match V₂ in order to reduce area consumption, any suitable voltage follower circuit may be used. For example, an operational amplifier may be used in place of the flipped voltage follower 426 to set V₃ equal to V₂.

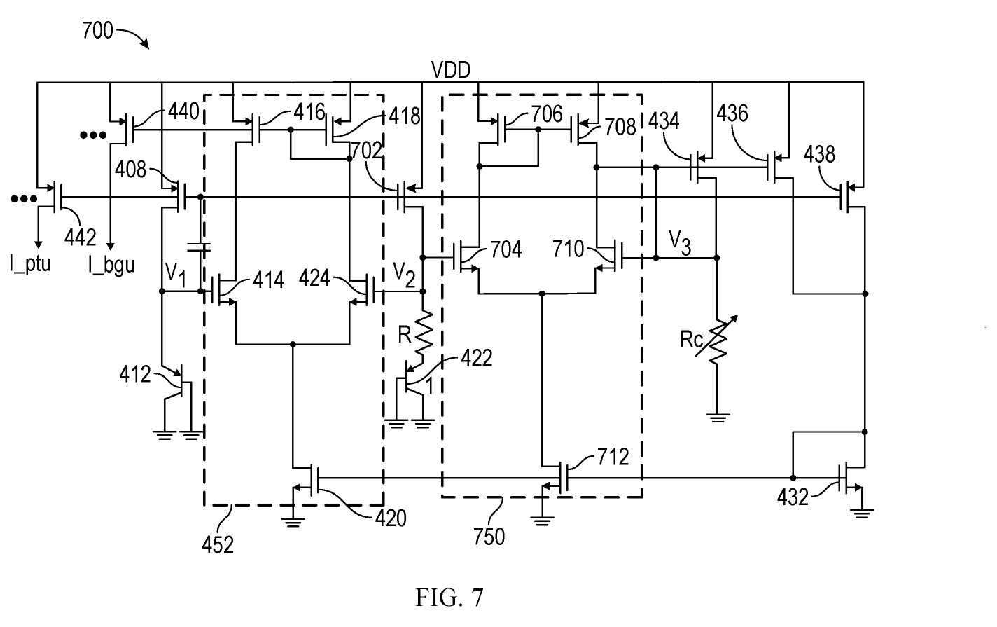

FIG. 7 illustrates a bandgap current generation circuit 700 implemented with an operational amplifier 750, in accordance with certain aspects of the present disclosure. As shown, the gate of transistor 424 may be coupled to a drain of transistor 702 and to a first input of the amplifier 750 at a gate of input NMOS transistor 704. A gate of transistor 424 may be coupled to the gate of transistor 704, and a source of transistor 702 may be coupled to the VDD rail. The amplifier 750 may also include an input NMOS transistor 710 having a gate coupled to a second input of the amplifier 750 (e.g., at the V₃ node) and a drain coupled to a drain of input transistor 704. The amplifier 750 also includes a PMOS transistor 706 having a source coupled to the VDD rail and a drain coupled to a gate of transistor 706. The amplifier 750 also includes a PMOS transistor 708 having a gate coupled to the gate of transistor 706 and a source coupled to the VDD rail. The drains of transistors 706, 708 may be coupled to the drains of transistors 704, 710. As shown, the amplifier 750 may include a tail transistor 712 having a gate coupled to a gate of transistor 432, a drain coupled to the sources of transistors 704, 710, and a source coupled to a reference potential node (e.g., electric ground) of the circuit 700. The second input of the amplifier 750 at the gate of transistor 710 may be coupled to a drain of transistor 434, a gate of transistor 434, and a drain of transistor 708, as shown. Thus, the amplifier 750 may drive the output node (e.g., V₃ node) of the amplifier 750 at the drain of transistor 708 to set V₂ equal to V₃.

The bandgap reference and bias current generator described herein may be implemented for each of multiple modules (e.g., synthesizers) that use bandgap reference bias currents. Thus, long routing from a common bias current generator circuit to each separate module may be avoided. Moreover, conventional implementations may use a common bias current generator circuit for multiple modules where each module includes a current mirror to mirror the current received from the common bias current generator circuit. In certain aspects of the present disclosure, the extra current mirror may not be used in each separate module to mirror the current from the common bias current generator circuit. Moreover, each module may have the flexibility to tune the bgu slope (e.g., the Vbg derivative over temperature, which may be turned via resistive element Rc). By implementing a bandgap reference and bias current generator in each module, the bandgap reference and bias current generator may be turned off when the module is not in use, saving power. However, if a common bias current generator circuit is used for multiple modules, the generator circuit may remain powered on even if a subset of the modules are not in use and are turned off.

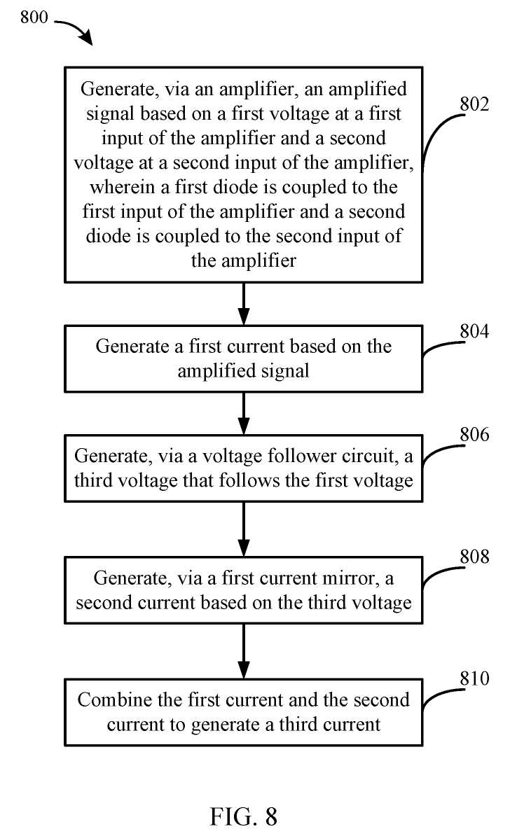

FIG. 8 is a flow diagram illustrating example operations 800 for current generation, in accordance with certain aspects of the present disclosure. The operations 800 may be performed, for example, by a bandgap current generation circuit such as the bandgap current generation circuit 400 or 700.

At block 802, the generation circuit generates, via an amplifier (e.g., amplifier 452), an amplified signal based on a first voltage (e.g., V₁ shown in FIG. 4 and FIG. 7) at a first input of the amplifier and a second voltage (e.g., V₂ shown in FIG. 4 and FIG. 7) at a second input of the amplifier. In some aspects, a first diode (e.g., diode-connected transistor 412) may be coupled to the first input of the amplifier, and a second diode (e.g., diode-connected transistor 422) may be coupled to the second input of the amplifier.

At block 804, the generation circuit generates a first current (e.g., I_ptu) based on the amplified signal. At block 806, the generation circuit generates, via a voltage follower circuit (e.g., voltage follower circuit 426), a third voltage (e.g., V₃) that follows the first voltage. At block 808, the generation circuit generates, via a first current mirror (e.g., current mirror 494), a second current based on the third voltage.

At block 810, the generation circuit combines the first current and the second current to generate a third current (e.g., I_bgu). In some aspects, the first current may be proportional to temperature. The second current may be complementary to temperature. The third current may be a bandgap current.

In some aspects, the generation circuit generates, via a second current mirror (e.g., current mirror implemented via transistors 432, 420), a tail current for the amplifier based on the third current. In some aspects, the generation circuit charges a capacitive element (e.g., Cstore shown in FIG. 4) during a startup phase. The capacitive element may be coupled to a gate of a tail transistor (e.g., transistor 420) of the amplifier.

### Example Aspects

Aspect 1: An apparatus for current generation, comprising: a first amplifier; a first diode coupled to a first input of the first amplifier; a second diode coupled to a second input of the first amplifier; a first transistor having a gate coupled to an output of the first amplifier and a drain coupled to a current combining node; a first current mirror; and a voltage follower including a first voltage follower node coupled to the second input of the first amplifier and a second voltage follower node coupled to a first branch of the first current mirror, wherein a second branch of the first current mirror is coupled to the current combining node.

Aspect 2: The apparatus of Aspect 1, further comprising a second current mirror having a first branch coupled to the current combining node, wherein a second branch of the second current mirror comprises a tail transistor of the first amplifier.

Aspect 3: The apparatus of Aspect 2, wherein the first branch of the second current mirror comprises a first current mirror transistor, and wherein the second branch of the second current mirror comprises a second current mirror transistor, the apparatus further comprising: a first cascode transistor coupled in cascode with the first current mirror transistor; and a second cascode transistor coupled in cascode with the second current mirror transistor.

Aspect 4: The apparatus of Aspect 2 or 3, wherein a current mirror ratio associated with the second current mirror is tunable.

Aspect 5: The apparatus according to any of Aspects 1–4, further comprising a variable resistive element coupled between the second voltage follower node and a reference potential node.

Aspect 6: The apparatus according to any of Aspects 1–5, further comprising a startup circuit comprising: a capacitive element; and an enable transistor coupled between a voltage rail and the capacitive element, wherein a startup circuit node between the capacitive element and the enable transistor is coupled to a gate of a tail transistor of the first amplifier.

Aspect 7: The apparatus of Aspect 6, further comprising a second current mirror having a first branch coupled to the current combining node, wherein a second branch of the second current mirror comprises the tail transistor of the first amplifier, and wherein the first branch comprises a current mirror transistor with a gate coupled to the startup circuit node.

Aspect 8: The apparatus of Aspect 6 or 7, wherein the startup circuit further comprises: a second transistor having a gate coupled to the startup circuit node and a source coupled to the first input of the first amplifier; and a third transistor having a drain coupled to a drain of the second transistor, a gate coupled to the first input of the first amplifier, and a source coupled to the output of the first amplifier.

Aspect 9: The apparatus according to any of Aspects 1–8, wherein the voltage follower comprises a flipped voltage follower.

Aspect 10: The apparatus according to any of Aspects 1–9, wherein the voltage follower comprises: a second transistor with a gate coupled to an output of the first amplifier; a third transistor with a gate coupled to the output of the first amplifier; a fourth transistor with a source coupled to the first voltage follower node and a drain coupled to a drain of the second transistor and a gate of the fourth transistor; and a fifth transistor with a gate coupled to the gate of the fourth transistor, a drain coupled to a drain of the third transistor, and a source coupled to the second voltage follower node.

Aspect 11: The apparatus according to any of Aspects 1–10, wherein the voltage follower comprises a second amplifier, the first voltage follower node comprising a first input of the second amplifier and the second voltage follower node comprising a second input of the second amplifier.

Aspect 12: The apparatus according to any of Aspects 1–11, further comprising: a second transistor including a source coupled to a voltage rail and a gate coupled to the output of the first amplifier; and a third diode coupled between a drain of the second transistor and the first input of the first amplifier.

Aspect 13: The apparatus according to any of Aspects 1–12, wherein: the first branch of the first current mirror includes a second transistor with a source coupled to a voltage rail and a drain coupled to the second voltage follower node; and the second branch of the first current mirror includes a third transistor with a source coupled to the voltage rail and a drain coupled to the current combining node.

Aspect 14: The apparatus according to any of Aspects 1–13, further comprising a second transistor having a gate coupled to the output of the first amplifier and configured to generate an output bandgap current.

Aspect 15: The apparatus according to any of Aspects 1–14, wherein the first amplifier comprises: a second transistor with a source coupled to a voltage rail; a third transistor with a source coupled to the voltage rail and a gate coupled to a gate of the second transistor and to a drain of the third transistor; a first input transistor having a gate coupled to the first input of the first amplifier and a drain coupled to a drain of the second transistor; and a second input transistor having a gate coupled to the second input of the first amplifier, a drain coupled to the drain of the third transistor.

Aspect 16: The apparatus of Aspect 15, further comprising a fourth transistor with a gate coupled to the gate of the second transistor.

Aspect 17: A method for current generation, comprising: generating, via an amplifier, an amplified signal based on a first voltage at a first input of the amplifier and a second voltage at a second input of the amplifier, wherein a first diode is coupled to the first input of the amplifier and a second diode is coupled to the second input of the amplifier; generating a first current based on the amplified signal; generating, via a voltage follower circuit, a third voltage that follows the first voltage; generating, via a first current mirror, a second current based on the third voltage; and combining the first current and the second current to generate a third current.

Aspect 18: The method of Aspect 17, wherein the first current is proportional to temperature, wherein the second current is complementary to temperature, and wherein the third current is a bandgap current.

Aspect 19: The method of Aspect 17 or 18, further comprising generating, via a second current mirror, a tail current for the amplifier based on the third current.

Aspect 20: The method according to any of Aspects 17–19, further comprising charging a capacitive element during a startup phase, wherein the capacitive element is coupled to a gate of a tail transistor of the amplifier.

Aspect 21: A wireless device, comprising: one or more mixers; and one or more synthesizers including one or more outputs coupled to one or more local oscillator (LO) inputs of the one or more mixers, respectively, wherein at least one of the one or more synthesizers includes: an amplifier; a first diode coupled to a first input of the amplifier; a second diode coupled to a second input of the amplifier; a transistor having a gate coupled to an output of the amplifier and a drain coupled to a current combining node; a current mirror; and a voltage follower including a first voltage follower node coupled to the second input of the amplifier and a second voltage follower node coupled to a first branch of the current mirror, wherein a second branch of the current mirror is coupled to the current combining node.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus for current generation, comprising:
a first amplifier;
a first diode coupled to a first input of the first amplifier;
a second diode coupled to a second input of the first amplifier;
a first transistor having a gate coupled to an output of the first amplifier and a drain coupled to a current combining node;
a first current mirror; and
a voltage follower including a first voltage follower node coupled to the second input of the first amplifier and a second voltage follower node coupled to a first branch of the first current mirror, wherein a second branch of the first current mirror is coupled to the current combining node.

2. The apparatus of claim 1, further comprising a second current mirror having a first branch coupled to the current combining node, wherein a second branch of the second current mirror comprises a tail transistor of the first amplifier.

3. The apparatus of claim 2, wherein the first branch of the second current mirror comprises a first current mirror transistor, and wherein the second branch of the second current mirror comprises a second current mirror transistor, the apparatus further comprising:
a first cascode transistor coupled in cascode with the first current mirror transistor; and
a second cascode transistor coupled in cascode with the second current mirror transistor.

4. The apparatus of claim 2, wherein a current mirror ratio associated with the second current mirror is tunable.

5. The apparatus of claim 1, further comprising a variable resistive element coupled between the second voltage follower node and a reference potential node.

6. The apparatus of claim 1, further comprising a startup circuit comprising:
a capacitive element; and
an enable transistor coupled between a voltage rail and the capacitive element, wherein a startup circuit node between the capacitive element and the enable transistor is coupled to a gate of a tail transistor of the first amplifier.

7. The apparatus of claim 6, further comprising a second current mirror having a first branch coupled to the current combining node, wherein a second branch of the second current mirror comprises the tail transistor of the first amplifier, and wherein the first branch comprises a current mirror transistor with a gate coupled to the startup circuit node.

8. The apparatus of claim 6, wherein the startup circuit further comprises:
a second transistor having a gate coupled to the startup circuit node and a source coupled to the first input of the first amplifier; and
a third transistor having a drain coupled to a drain of the second transistor, a gate coupled to the first input of the first amplifier, and a source coupled to the output of the first amplifier.

9. The apparatus of claim 1, wherein the voltage follower comprises a flipped voltage follower.

10. The apparatus of claim 1, wherein the voltage follower comprises:
a second transistor with a gate coupled to an output of the first amplifier;
a third transistor with a gate coupled to the output of the first amplifier;
a fourth transistor with a source coupled to the first voltage follower node and a drain coupled to a drain of the second transistor and a gate of the fourth transistor; and
a fifth transistor with a gate coupled to the gate of the fourth transistor, a drain coupled to a drain of the third transistor, and a source coupled to the second voltage follower node.

11. The apparatus of claim 1, wherein the voltage follower comprises a second amplifier, the first voltage follower node comprising a first input of the second amplifier and the second voltage follower node comprising a second input of the second amplifier.

12. The apparatus of claim 1, further comprising:
a second transistor including a source coupled to a voltage rail and a gate coupled to the output of the first amplifier; and
a third diode coupled between a drain of the second transistor and the first input of the first amplifier.

13. The apparatus of claim 1, wherein:
the first branch of the first current mirror includes a second transistor with a source coupled to a voltage rail and a drain coupled to the second voltage follower node; and
the second branch of the first current mirror includes a third transistor with a source coupled to the voltage rail and a drain coupled to the current combining node.

14. The apparatus of claim 1, further comprising a second transistor having a gate coupled to the output of the first amplifier and configured to generate an output bandgap current.

15. The apparatus of claim 1, wherein the first amplifier comprises:
a second transistor with a source coupled to a voltage rail;
a third transistor with a source coupled to the voltage rail and a gate coupled to a gate of the second transistor and to a drain of the third transistor;
a first input transistor having a gate coupled to the first input of the first amplifier and a drain coupled to a drain of the second transistor; and
a second input transistor having a gate coupled to the second input of the first amplifier, a drain coupled to the drain of the third transistor.

16. The apparatus of claim 15, further comprising a fourth transistor with a gate coupled to the gate of the second transistor.

17. A method for current generation, comprising:
generating, via an amplifier, an amplified signal based on a first voltage at a first input of the amplifier and a second voltage at a second input of the amplifier, wherein a first diode is coupled to the first input of the amplifier and a second diode is coupled to the second input of the amplifier;
generating a first current based on the amplified signal;
generating, via a voltage follower circuit, a third voltage that follows the first voltage;
generating, via a first current mirror, a second current based on the third voltage; and
combining the first current and the second current to generate a third current.

18. The method of claim 17, wherein the first current is proportional to temperature, wherein the second current is complementary to temperature, and wherein the third current is a bandgap current.

19. The method of claim 17, further comprising generating, via a second current mirror, a tail current for the amplifier based on the third current.

20. The method of claim 17, further comprising charging a capacitive element during a startup phase, wherein the capacitive element is coupled to a gate of a tail transistor of the amplifier.

21. A wireless device, comprising:
one or more mixers; and
one or more synthesizers including one or more outputs coupled to one or more local oscillator (LO) inputs of the one or more mixers, respectively, wherein at least one of the one or more synthesizers includes:
an amplifier;
a first diode coupled to a first input of the amplifier;
a second diode coupled to a second input of the amplifier;
a transistor having a gate coupled to an output of the amplifier and a drain coupled to a current combining node;
a current mirror; and
a voltage follower including a first voltage follower node coupled to the second input of the amplifier and a second voltage follower node coupled to a first branch of the current mirror, wherein a second branch of the current mirror is coupled to the current combining node.
